(19) United States
(12) Patent Application Publication
(10) Pub. No.: US 2013/0163621 A1
(43) Pub. Date: Jun. 27, 2013

(54) EXTERNAL CAVITY TUNABLE LASER MODULE

(71) Applicant: Electronics and Telecommunication Research Institute, Daejeon (KR)

(72) Inventors: Ki-Hong YOON, Daejeon (KR); O-Kyun Kwon, Daejeon (KR); Su Hwan Oh, Daejeon (KR); Kisoo Kim, Daejeon (KR); Byungseok Choi, Daejeon (KR); Hyun Soo Kim, Daejeon (KR)

(73) Assignee: Electronics and Telecommunication Research Institute, Daejeon (KR)

(21) Appl. No.: 13/721,997

(22) Filed: Dec. 20, 2012

(30) Foreign Application Priority Data
Dec. 22, 2011 (KR) 10-2011-0140235

(51) Int. Cl. H01S 3/10

(52) U.S. Cl. CPC H01S 3/10
USPC 372/20

(57) ABSTRACT

Disclosed is an external cavity tunable laser module including a substrate; a mirror surface that is formed on the substrate to reflect a laser incoming from the outside; a transmissive liquid crystal filter that is formed at a rear side of the mirror surface to select and tune a wavelength of the laser reflected through the mirror surface; and a light source chip that is formed at a rear side of the transmissive liquid crystal filter to reflect the laser that passes through the transmissive liquid crystal filter at a specific wavelength interval to form a plurality of channels and tune wavelengths of the channels.

### CROSS-REFERENCE TO RELATED APPLICATIONS

This application is based on and claims priority from Korean Patent Application No. 10-2011-0140235, filed on 2011 Dec. 22, with the Korean Intellectual Property Office, the disclosure of which is incorporated herein in its entirety by reference.

### TECHNICAL FIELD

The present disclosure relates to a laser module, and more specifically, to an external cavity tunable laser module that has a high degree of integration for fast modulation and high output and includes a light source chip, a transmissive liquid crystal filter, and a mirror surface.

### BACKGROUND

As the importance of a wavelength division multiplexing-passive optical network (WDM-PON) that is capable of providing a large amount of communication service by wavelength division is increased, development of a light source which is used for the optical transmission network becomes important. The WDM-PON requires a fast modulation tunable laser module that minutely tunes and modulates a wavelength of channels at high speed while tuning the wavelength of channels having a predetermined wavelength interval.

An example of a representative fast modulation tunable laser module which has been suggested so far includes a tunable laser module that uses a sampled grating distributed Bragg reflector (SG-DBR) disclosed in U.S. Pat. No. 4,896,325. The tunable laser module has a structure in which a gain section and a phase shift section are integrated between two SG-DBRs to form laser tuning and then an optical modulator is integrated at an end of one of two SG-DBRs to modulate an optical signal output from the SG-DBR. The tunable laser module that uses the SG-DBR uses a Vernier effect by two SG-DBRs in order to improve a DBR structure having a narrow tunable range of 10 nm or lower. Therefore, the tunable laser module that uses the SG-DBR requires various control circuits such as a Vernier control circuit, a control circuit for discontinuous wavelength shift, and a control circuit for a phase shift section. Thus, the control of the tunable laser module is very complex and it is hard to obtain a stable output wavelength.

In the meantime, in order to substitute for the tunable laser module using the SG-DBR, a tunable laser module using two ring resonators having lightly different free spectral ranges (FSR) is announced (paper: PHOTONICS TECHNOLOGY LETTERS, Vol. 14, No. 5, p600, 2002, IEEE PHOTONICS TECHNOLOGY LETTERS, Vol. 21, No. 13, p851, 2009, IEEE Journal of Lightwave Technology, Vol. 24, No. 4, p1865, 2006). In the tunable laser module, one of ring resonators have refractive index fixed and the other one have refractive index variable so that an output wavelength of the laser is varied by an interval of the FSR. However, since the FSR difference between the two ring resonators is very small, it is very difficult to control in order to guarantee stabilization of the output wavelength of the laser.

A planar lightwave circuit (PLC) based external cavity tunable laser module is an external cavity tunable laser module that combines the PLC to a reflective superluminescent diode (R-SLD) to obtain a good mass production. If a polymer based PLC is used instead of silica based PLC, since a thermo-optic coefficient of the polymer is very high, a wider wavelength region may be tuned.

A polymer based external cavity tunable laser module that has a 2.5 Gbps modulation speed by direct modulation is described in detail in a recently announced paper (paper: OPTICS EXPRESS, Vol. 18, No. 6, p 5556, 2010). The polymer based external cavity tunable laser module has a semi insulating buried hetero structure which may reduce a parasitic capacitance of an R-SLD used to obtain a gain in the external cavity tunable laser module in order to have a 2.5 Gbps or higher modulation speed by the direct modulation, and a length of the R-SLD needs to be very short. Therefore, the manufacturing process of the R-SLR is very difficult and the packaging process of the external cavity tunable laser module is also complex.

Even though an external cavity tunable laser module using a reflective liquid crystal filter that uses a diffraction grating is announced (paper: IEEE Photonics Technology letters, vol. 19, no. 14, pp. 1099-1101), the laser module has a structure in that the laser resonance is generated by a single side reflection of a gain chip. Therefore, no other optical elements are integrated in the gain chip. Even though there is an attempt to implement a high integration gain chip by making a gap in the gain chip, but it is difficult to control the reflectance and transmittance through the gap.

There are an external cavity tunable laser module that uses a fiber Bragg grating (FBG) having a modulation speed of 10 Gbps through direct modulation (paper: IEEE Photonics Technology letters, vol. 10, no. 12, pp. 1691-1693, IEE Electronics Letters, vol. 35, no. 20, pp. 1737-1738) and an external cavity tunable laser module (RIO corporation, USA) using silica in which a Bragg grating is formed. However, the external cavity tunable laser modules use the silica, and thus may be not used as a tunable laser module.

In the polymer based external cavity tunable laser module in the related art, the laser is tuned between the polymer Bragg grating reflector and the R-SLD so that an optical modulator is not integrated in the external cavity tunable laser module but an expensive external optical modulator for fast modulation is required.

### SUMMARY

The present disclosure has been made in an effort to provide an external cavity tunable laser module that has a low power, a wide wavelength tunable wavelength range, and a high wavelength tunable speed and performs fast modulation.

The present disclosure also has been made in an effort to provide an external cavity tunable laser module having a stable laser output characteristic.

An exemplary embodiment of the present disclosure provides an external cavity tunable laser module including a substrate; a mirror surface that is formed on the substrate to reflect a laser incoming from the outside; a transmissive liquid crystal filter that is formed at a rear side of the mirror surface to select and tune a wavelength of the laser reflected through the mirror surface; and a light source chip that is formed at a rear side of the transmissive liquid crystal filter to reflect the laser that passes through the transmissive liquid crystal filter at a specific wavelength interval to form a plurality of channels and tune wavelengths of the channels.

According to exemplary embodiments of the present disclosure, by providing an external cavity tunable laser module including a light source chip having a ring resonator and a transmissive liquid crystal filter, it is possible to minutely tune wavelengths of channels while tuning the wavelengths of channels having a predetermined wavelength interval. Further, a wide tunable range is provided at a low power consumption and a fast wavelength tunable speed is provided. Further, the ring resonator in the light source chip functions as an etalon filter so that the etalon filter does not need to be inserted at an output terminal of the laser module.

By providing an external cavity tunable laser module including a light source chip in which an optical modulating unit and an optical amplifying unit are integrated in one body, an external cavity tunable laser module that allows a fast modulation and a high output is provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are a side view and a plan view of an external cavity tunable laser module according to an exemplary embodiment of the present disclosure.

FIGS. 3 and 4 are views illustrating a front surface and an upper surface of a transmissive liquid crystal filter according to an exemplary embodiment of the present disclosure.

FIG. 5 is a graph illustrating a transmission characteristic of a transmissive liquid crystal filter according to an exemplary embodiment of the present disclosure.

FIG. 6 is a graph illustrating a transmission characteristic when a laser passes back and forth through a transmissive liquid crystal filter by the reflection of a mirror surface.

FIG. 7 is a graph illustrating a wavelength tunable characteristic of a transmissive liquid crystal filter according to an exemplary embodiment of the present disclosure.

FIGS. 8 and 9 are a plan view and a side view illustrating a structure of a light source chip according to an exemplary embodiment of the present disclosure.

FIGS. 10 and 11 are plan views illustrating a configuration of an external cavity tunable laser module according to another exemplary embodiment of the present disclosure.

FIGS. 12 to 14 are views illustrating an external electrode arrangement of an external cavity tunable laser module according to an exemplary embodiment of the present disclosure.

### DETAILED DESCRIPTION

In the fallowing detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.|[K1]

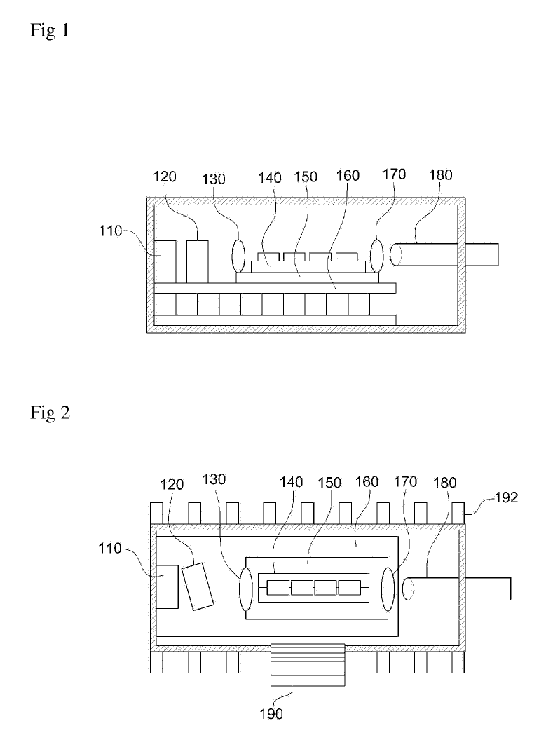

FIGS. 1 and 2 are a side view and a plan view of an external cavity tunable laser module according to an exemplary embodiment of the present disclosure.

Referring to FIGS. 1 and 2, the external cavity tunable laser module includes a mirror surface 110, a transmissive liquid crystal filter 120, and a light source chip 140.

The mirror surface 110 and the transmissive liquid crystal filter 120 are actively aligned with the light source chip 140 by a first lens 130, and the light source chip 140 is actively aligned with an optical fiber 180 by a second lens 170. In this case, the transmissive liquid crystal filter 120 is mounted so as to be inclined at 1 to 10 degrees from an optical axis in order to reflect and remove unnecessary wavelength components other than a wavelength that penetrates through the transmissive liquid crystal filter 120.

The external cavity tunable laser module according to the exemplary embodiment of the present disclosure further includes a temperature control unit 160 below the transmissive liquid crystal filter 120 and the light source chip 140 in order to stabilize an output of the laser when the output characteristic of the laser is changed depending on the temperature change of the transmissive liquid crystal filter 120 and the light source chip 140.

The external cavity tunable laser module according to the exemplary embodiment of the present disclosure may further include an RF connector 190 that applies an electric signal having a high modulation speed to an optical modulating unit 144 which will be described below.

The external cavity tunable laser module according to the exemplary embodiment of the present disclosure further includes a U shaped structure 150 in order to fix the lenses 130 and 170 and the light source chip 140. Here, the U shaped structure 150 may be formed of a metal material such as SUS having a good processability. Even though not illustrated, the external cavity tunable laser module according to the exemplary embodiment of the present disclosure may further include a structure having a high thermal conductivity between the U shaped structure 150 and the light source chip 140 in order to efficiently transmit the heat of the light source chip 140.

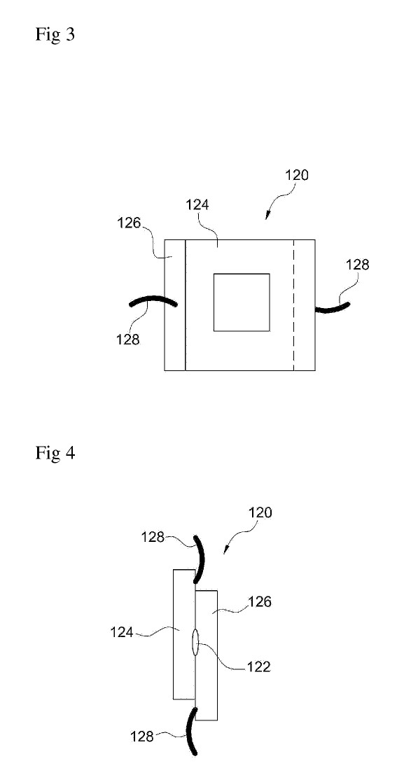

FIGS. 3 and 4 are views illustrating a front surface and an upper surface of a transmissive liquid crystal filter according to an exemplary embodiment of the present disclosure.

Referring to FIGS. 3 and 4, the transmissive liquid crystal filter 120 according to the exemplary embodiment of the present disclosure is configured by a liquid crystal material 122 filled between two glass plates 124 and 126 having a high reflectance and electrodes 128 attached on the two glass plates 124 and 126.

The transmissive liquid crystal filter 120 uses a Fabry-Perot etalon effect so that a free spectral range (FSR) is determined by an interval between the two glass plates 124 and 126 and a refractive index of the liquid crystal material 122 to determine a tunable wavelength range. In other words, if a voltage is applied to the electrodes 120 which are attached on the two glass plates 124 and 126, the refractive index of the liquid crystal material 122 is changed to change the FSR of the transmissive liquid crystal filter 120 so that the transmissive liquid crystal filter 120 tunes a wavelength of the laser.

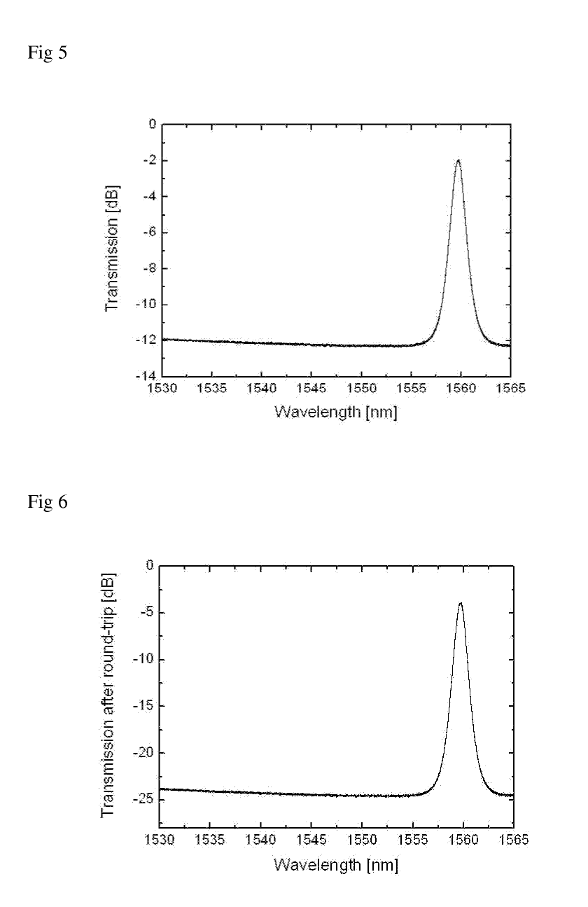

FIG. 5 is a graph illustrating a transmission characteristic of the transmissive liquid crystal filter according to the exemplary embodiment of the present disclosure and FIG. 6 is a graph illustrating a transmission characteristic when a laser passes back and forth through the transmissive liquid crystal filter by the reflection of the mirror surface.

As illustrated in FIGS. 5 and 6, when the laser passes back and forth through the transmissive liquid crystal filter 120 by the reflection of the mirror surface 110, a full width half maximum (FWHM) of the transmissive liquid crystal filter 120 is reduced. For example, when a full width half maximum of the transmissive liquid crystal filter 120 is 1.4 nm, if the laser passes back and forth through the transmissive liquid crystal filter 120 by the reflection of the mirror surface 110, the a full width half maximum of the transmissive liquid crystal filter 120 becomes 0.9 nm. Therefore, if the mirror surface 110 and the transmissive liquid crystal filter 120 are used as described in the exemplary embodiment of the present disclosure, the transmissive liquid crystal filter 120 has a narrow full width half maximum.

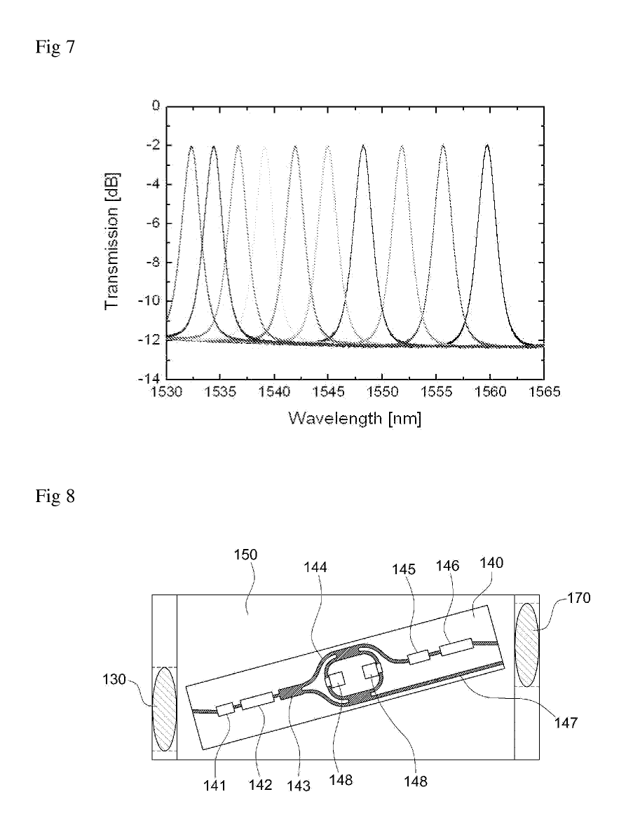

FIG. 7 is a graph illustrating a wavelength tunable characteristic of the transmissive liquid crystal filter according to the exemplary embodiment of the present disclosure.

As illustrated in FIG. 7, if a voltage is applied to the transmissive liquid crystal filter 120 from the outside, the refractive index of the transmissive liquid crystal filter 120 is changed by a field effect so that a transmitting wavelength is changed. Accordingly, if the transmitting wavelength of the transmissive liquid crystal filter 120 is changed by the field effect, the power consumption for tuning the wavelength is very lowered and a wavelength tunable speed is very increased.

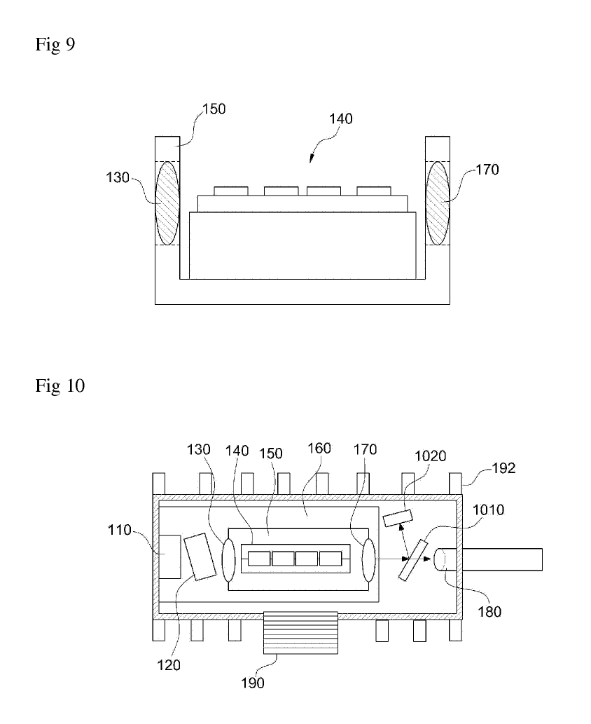

FIGS. 8 and 9 are a plan view and a side view illustrating a structure of the light source chip according to an exemplary embodiment of the present disclosure.

Referring to FIGS. 8 and 9, the light source chip 140 according to the exemplary embodiment of the present disclosure is coupled to lenses 130 and 170 on the U shaped structure 150 and includes a phase shifter 141, a gain unit 142, a com reflecting unit, an optical modulating unit 145, and an optical amplifying unit 146.

The phase shifter 141 minutely adjusts an output wavelength oscillated from the laser and stabilizes the wavelength.

The gain unit 142 provides a gain for laser oscillation.

The com reflecting unit according to the exemplary embodiment of the present disclosure includes an optical coupling unit 143 and a ring resonator 144. Two input terminals of the ring resonator 144 are coupled to two output terminals of the optical coupling unit 143 to reflect the laser at a specific wavelength interval. One of the two output terminals outputs the laser and the other one outputs a reflection signal. In this case, since the reflection signal generated from the other output terminal of the ring resonator 144 lowers the output characteristics of the laser, the reflection signal is removed by an absorbing unit 147.

Accordingly, the external cavity tunable laser module according to the exemplary embodiment of the present disclosure forms laser resonance for oscillating the laser by the reflection by the mirror surface 110 and the transmissive liquid crystal filter 120 and the reflection by the com reflecting unit. Accordingly, the external cavity tunable laser module according to the exemplary embodiment of the present disclosure uses the transmissive liquid crystal filter 120 and the com reflecting unit together so as to output the more stable single wavelength component at a specific wavelength interval as compared with the external cavity tunable laser module that uses only the transmissive liquid crystal filter 120.

The com reflecting unit according to the exemplary embodiment of the present disclosure further includes a minute phase shift 148 to minutely change the wavelength output from the external cavity tunable laser module while changing the phase of the com reflecting unit.

In the meantime, if the reflectance of the input terminal and the output terminal of the light source chip 140 is high, an internal reflection mode is generated by the internal reflection, which affects the stability of the output wavelength of the external cavity tunable laser module and deteriorates the performance of the external cavity tunable laser module due to the internal damage. Therefore, in the exemplary embodiment, in order to reduce the reflectance of the input terminal and the output terminal of the light source chip 140, the input terminal and the output terminal are non-reflectively coated and waveguides of the input terminal and the output terminal are inclined so that the reflectance becomes 0.1% or lower. As described above, if the waveguides of the input terminal and the output terminal of the light source chip 140 are inclined, the optical axes of the input terminal and the output terminal of the light source chip 140 are varied. Therefore, the position of the first lens 130 that aligns the transmissive liquid crystal filter 120 and the light source chip 140 and the position of the second lens 170 that aligns the light source chip 140 and the optical fiber 180 are varied.

In the case of a general external cavity tunable laser module, mode hopping is generated by the external resonance mode to change the output wavelength of the laser. In contrast, the external cavity tunable laser module according to the exemplary embodiment of the present disclosure includes the phase shift 141 in the light source chip 140 in order to compensate the change in the output wavelength of the laser to stabilize the output characteristic of the laser.

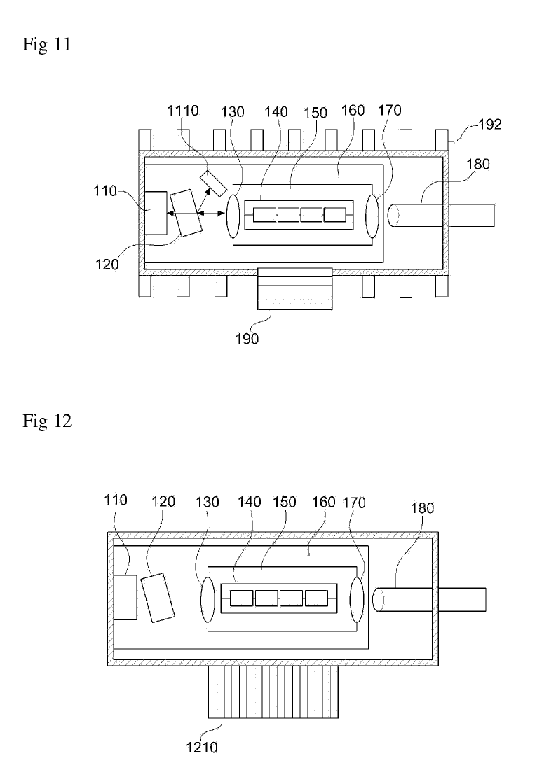

FIGS. 10 and 11 are plan views illustrating a configuration of an external cavity tunable laser module according to another exemplary embodiment of the present disclosure.

Referring to FIG. 10, the external cavity tunable laser module according to the exemplary embodiment of the present disclosure uses a spectrometer 1010 to diverge a part of laser output from the output terminal of the light source chip 140 and uses a monitor detector (photo detector: PD) 1020 to measure an intensity of the diverged laser to control the output characteristic.

Referring to FIG. 11, the external cavity tunable laser module according to the exemplary embodiment of the present disclosure includes a monitor detector 1110 between the transmissive liquid crystal filter 120 and the first lens 130 and uses the monitor detector 1110 to detect a laser reflected from the transmissive liquid crystal filter 120 disposed at an angle to control the output characteristic. In other words, when the laser is oscillated by the light source chip 140, the transmissive liquid crystal filter 120, and the mirror surface 110, the external cavity tunable laser module detects the oscillated laser by the monitor detector 1110 to control the output characteristic. Therefore, the external cavity tunable laser module of FIG. 11 does not diverge the output, which is different from the external cavity tunable laser module of FIG. 10, so that the output characteristic is controlled without losing the output of the laser.

FIGS. 12 to 14 are views illustrating an external electrode arrangement of an external cavity tunable laser module according to an exemplary embodiment of the present disclosure.

Referring to FIG. 12, in the external cavity tunable laser module of FIG. 2, as external electrodes, 15 electrode pins 192 and one RF connector 190 are disposed around the external cavity tunable laser module with an regular interval. In contrast, in the external cavity tunable laser module of FIG. 12, an external electrode 1210 is disposed on one side of the external cavity tunable laser module.

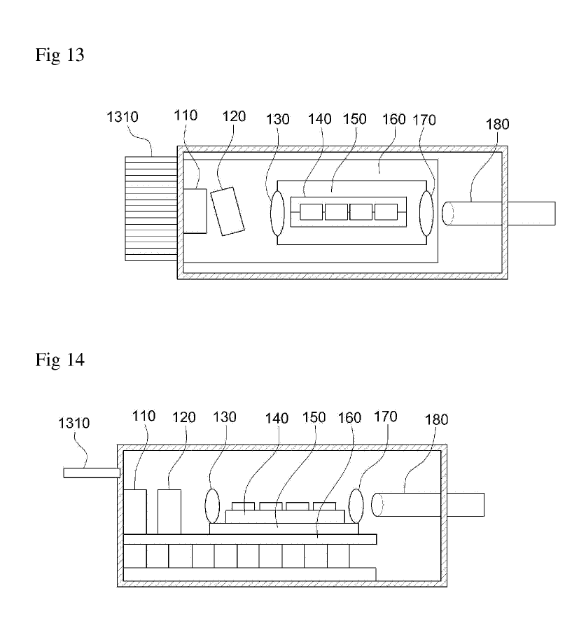

As illustrated in FIGS. 13 and 14, the external electrode 1310 may be disposed at a rear side of the external cavity tunable laser module. Such arrangement of the external electrode 1310 may reduce the width of the external cavity tunable laser module, which is suitable for a small-sized laser module.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An external cavity tunable laser module, comprising:
a substrate;
a mirror surface that is formed on the substrate to reflect a laser incoming from the outside;
a transmissive liquid crystal filter that is formed at a rear side of the mirror surface to select and tune a wavelength of the laser reflected through the mirror surface; and
a light source chip that is formed at a rear side of the transmissive liquid crystal filter to reflect the laser that passes through the transmissive liquid crystal filter at a specific wavelength interval to form a plurality of channels and tune wavelengths of the channels.

2. The external cavity tunable laser module of claim 1, wherein the transmissive liquid crystal filter includes:
two glass plates;
a liquid crystal material filled between the two glass plates; and
an electrode that applies a voltage to the two glass plates.

3. The external cavity tunable laser module of claim 1, wherein the transmissive liquid crystal filter is mounted so as to be inclined at about 1 to 10 degrees with respect to an optical axis.

4. The external cavity tunable laser module of claim 1, further comprising:
a temperature control unit that is formed below the light source chip to stabilize the output of the laser.

5. The external cavity tunable laser module of claim 1, wherein an input terminal and an output terminal of the light source chip are non-reflectively coated.

6. The external cavity tunable laser module of claim 5, wherein waveguides of the input terminal and the output terminal are inclined.

7. The external cavity tunable laser module of claim 1, wherein the light source chip includes at least two of a phase shifter, a gain unit, a com reflecting unit, an optical modulating unit, and an optical amplifying unit.

8. The external cavity tunable laser module of claim 7, wherein the com reflecting unit includes:
an optical coupling unit that outputs the laser to two output terminals; and
a ring resonator of which two input terminals are coupled to two output terminals of the optical coupling unit, respectively to reflect the laser at a specific wavelength interval, one of the two output terminals outputting the laser and the other one outputting a reflection signal.

9. The external cavity tunable laser module of claim 8, wherein the light source chip further includes:
an absorbing unit that absorbs a reflection signal output from the other output terminal of the ring resonator.

10. The external cavity tunable laser module of claim 1, further comprising:
a first lens that actively aligns the mirror surface, the transmissive liquid crystal filter, and the light source chip; and
a second lens that actively aligns the light source chip and an optical fiber.

11. The external cavity tunable laser module of claim 10, further comprising:
a U shaped structure that fixes the first lens, the light source chip, and the second lens.

12. The external cavity tunable laser module of claim 11, wherein the U shaped structure is formed of a metal material.

13. The external cavity tunable laser module of claim 1, further comprising:
a monitor detector that detects an intensity of the laser which is reflected toward an inclined angle of the transmissive liquid crystal filter.

14. The external cavity tunable laser module of claim 1, further comprising:
a spectrometer that diverges the laser output from the light source chip; and
a monitor detector that detects an intensity of the laser diverged by the spectrometer.

15. The external cavity tunable laser module of claim 1, further comprising:
an external electrode which includes a plurality of pins, and an RF connector or a flexible circuit board electrode.

16. The external cavity tunable laser module of claim 15, wherein the external electrode is mounted around, at one side, or on a rear surface of the external cavity tunable laser module.
